(19) United States
(12) Patent Application Publication
(10) Pub. No.: US 2026/0044986 A1
(43) Pub. Date: Feb. 12, 2026

(54) OPTICAL APPARATUS, INSPECTION APPARATUS, IMAGE-CAPTURING METHOD, AND NON-TRANSITORY COMPUTER READABLE MEDIUM

(71) Applicant: Lasertec Corporation, Yokohama (JP)

(72) Inventors: Michiteru MIZOGUCHI, Yokohama-shi (JP); Minoru HOSOMI, Yokohama-shi (JP)

(21) Appl. No.: 19/289,921

(22) Filed: Aug. 4, 2025

(30) Foreign Application Priority Data
Aug. 6, 2024 (JP) 2024-129744

(51) Int. Cl. G06T 7/00; G06T 5/70

(52) U.S. Cl. CPC G06T 7/97; G06T 5/70

(57) ABSTRACT

An optical system irradiates an object with illumination light and guides a secondary ray generated when the object is irradiated with the illumination light to a detector. Optical path length adjustment mechanism adjusts an optical path length between the object and the detector. one or more processors execute a program stored in a memory to: generate an image of the object based on detection results of the secondary ray by the detector, control the optical path length adjustment mechanism to change the optical path length between the object and the detector, acquire multiple images of the object while changing the optical path length between the object and the detector, and generate the image of the object based on a cumulative result of the acquired multiple images.

### INCORPORATION BY REFERENCE

This application is based upon and claims the benefit of priority from Japanese patent application No. 2024-129744, filed on Aug. 6, 2024, the disclosure of which is incorporated herein in its entirety by reference for all purposes.

### BACKGROUND

The present disclosure relates to an optical apparatus, an inspection apparatus, an image-capturing method, and a non-transitory computer readable medium.

As semiconductor process nodes become smaller, it is urgently necessary to improve the sensitivity of inspection of a semiconductor wafer, a photomask, and the like. For example, as a foreign matter inspection of a sample such as a mask, a technique for inspecting a sample by capturing an image of the sample is widely known (Japanese Unexamined Patent Application Publication Nos. 2022-161475 and 2023-117036).

### SUMMARY

However, there are irregularities and the like in a sample which are finer than a pattern to be inspected, and an image of noise caused by the irregularities may be captured when an image of the sample is captured.

A possible reason why an image of noise caused by minute irregularities is captured is as follows. Namely, it is known that an image becomes bright when the focal position of an optical system is shallow with respect to an object having a projecting shape while it becomes dark when the focal position of an optical system is deep, and that an image becomes dark when the focal position of an optical system is shallow with respect to an object having a recessed shape while it becomes bright when the focal position of an optical system is deep, and hence it is considered that a phenomenon similar to the above ones may have occurred for the fine irregularities on the sample.

As described above, in a case where there are irregularities which are different in distance from the optical system from the position to be observed on the sample, even if the irregularities are minute, bright and dark noise is generated in the image of the sample due to the deviation from the focal position. As a result, the accuracy of the inspection conducted based on the image of the sample may be deteriorated. Therefore, there is a demand to establish a method for capturing an image of a sample while reducing noise caused by irregularities in the sample.

An optical apparatus according to the present disclosure includes: a detector configured to detect light; an optical system configured to irradiate an object with illumination light and guide a secondary ray generated when the object is irradiated with the illumination light to the detector; an optical path length adjustment mechanism configured to adjust an optical path length between the object and the detector; a memory storing a program; and one or more processors configured to execute the program stored in the memory to: generate an image of the object based on detection results of the secondary ray by the detector; control the optical path length adjustment mechanism to change the optical path length between the object and the detector; acquire multiple images of the object while changing the optical path length between the object and the detector; and generate the image of the object based on a cumulative result of the acquired multiple images.

An inspection apparatus according to the present disclosure includes: the above-described optical apparatus; and an inspection unit configured to inspect the object based on the image of the object acquired by the image processing unit.

An image-capturing method according to the present disclosure is performed in an optical apparatus including: a detector configured to detect light; an optical system configured to irradiate an object with illumination light and guide a secondary ray generated when the object is irradiated with the illumination light to the detector; and an optical path length adjustment mechanism configured to adjust an optical path length between the object and the detector; a memory storing a program; and one or more processors configured to execute the program stored in the memory, the image-capturing method causing the one or more processors to execute the program to: generate an image of the object based on detection results of the secondary ray by the detector; control the optical path length adjustment mechanism to change the optical path length between the object and the detector; acquire multiple images of the object while changing the optical path length between the object and the detector; and generate the image of the object based on a cumulative result of the acquired multiple images.

A non-transitory computer readable medium storing a program according to the present disclosure causes a processing apparatus to perform processes, the processing apparatus being configured as a computer that is configured to perform image-capturing processing in an optical apparatus including: a detector configured to detect light; an optical system configured to irradiate an object with illumination light and guide a secondary ray generated when the object is irradiated with the illumination light to the detector; and an optical path length adjustment mechanism configured to adjust an optical path length between the object and the detector; a memory storing the program; and one or more processors configured to execute the program stored in the memory, the program causing the one or more processors to: generate an image of the object based on detection results of the secondary ray by the detector; control the optical path length adjustment mechanism to change the optical path length between the object and the detector; acquire multiple images of the object while changing the optical path length between the object and the detector; and generate the image of the object based on a cumulative result of the acquired multiple images.

An optical apparatus according to the present disclosure includes: a detector configured to detect light; an optical system configured to irradiate an object with illumination light and guide a secondary ray generated when the object is irradiated with the illumination light to the detector; a holding unit configured to hold the object; a driving unit configured to drive the holding unit; a memory storing a program; and one or more processors configured to execute the program stored in the memory to: generate an image of the object based on detection results of the secondary ray by the detector; control the driving unit so as to move the holding unit in a state where a component in a thickness direction of the object is included so that an optical path length between the object and the detector is changed; acquire multiple images of the object while changing the optical path length between the object and the detector; and generate the image of the object based on a cumulative result of the acquired multiple images.

An optical apparatus according to the present disclosure includes: a detector configured to detect light; an optical system configured to irradiate an object with illumination light and guide a secondary ray generated when the object is irradiated with the illumination light to the detector; a memory storing a program; and one or more processors configured to execute the program stored in the memory to: generate an image of the object based on detection results of the secondary ray by the detector; control the optical system to change at least one of a focal length of the optical system on a side of the object and a focal length of the optical system on a side of the detector so that an optical path length between the object and the detector is changed; acquire multiple images of the object while changing the optical path length between the object and the detector; and generate the image of the object based on a cumulative result of the acquired multiple images.

An optical apparatus according to the present disclosure includes: a detector configured to detect light; an optical system configured to irradiate an object with illumination light and guide a secondary ray generated when the object is irradiated with the illumination light to the detector; a memory storing a program; and one or more processors configured to execute the program stored in the memory to: generate an image of the object based on detection results of the secondary ray by the detector; control the optical system to change at least one of a position of the optical system relative to the object and a position of the optical system relative to the detector so that an optical path length between the object and the detector is changed, acquire multiple images of the object while changing the optical path length between the object and the detector; and generate the image of the object based on a cumulative result of the acquired multiple images.

An optical apparatus according to the present disclosure includes: a detector configured to detect light; an optical system configured to irradiate an object with illumination light and guide a secondary ray generated when the object is irradiated with the illumination light to the detector; a detector driving unit configured to drive the detector; and a memory storing a program; and one or more processors configured to execute the program stored in the memory to: generate an image of the object based on detection results of the secondary ray by the detector; control the detector driving unit so as to move the detector in a state where a component in a thickness direction of the detector is included so that the optical path length between the object and the detector is changed, acquire multiple images of the object while changing the optical path length between the object and the detector; and generate the image of the object based on a cumulative result of the acquired multiple images.

According to the present disclosure, it is possible to capture an image of a sample while reducing noise.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing an example of a configuration of an optical apparatus according to a first embodiment;

FIG. 2 is a diagram showing an example of a configuration of an inspection apparatus according to the first embodiment;

FIG. 3 is a diagram schematically showing a configuration of a detector;

FIG. 4 is a diagram showing an example of movement of a stage;

FIG. 5 is a diagram schematically showing a progress when an image of a specific area of a sample is captured;

FIG. 6 is a diagram schematically showing a configuration of an optical apparatus according to a second embodiment;

FIG. 7 is a diagram schematically showing a change in a focal length when an objective lens is configured as a zoom lens;

FIG. 8 is a diagram schematically showing a configuration of an optical apparatus according to a third embodiment;

FIG. 9 is a diagram schematically showing a relationship between the detector and a focus of an optical system on the side of the detector when the detector is moved in a Z-axis direction; and

FIG. 10 is a diagram showing an example of a configuration of a computer for implementing an optical apparatus.

### DESCRIPTION OF EMBODIMENTS

A specific configuration of the present embodiment will be described below with reference to the drawings. The following description shows preferred embodiment of the present disclosure, and the scope of the present disclosure is not limited to the following embodiments. In the following description, elements denoted by the same reference numerals or symbols indicate substantially similar contents.

### First Embodiment

An optical apparatus according to a first embodiment will be described. The optical apparatus according to this embodiment is configured as an optical apparatus incorporated into an inspection apparatus of a photomask used in a semiconductor manufacturing process. The inspection apparatus inspects defects of a sample based on an image of the sample captured by the optical apparatus.

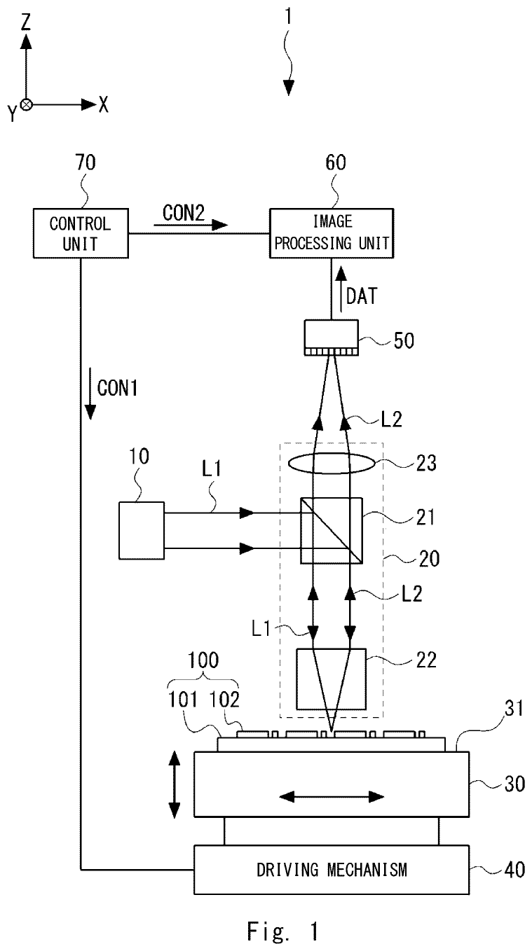

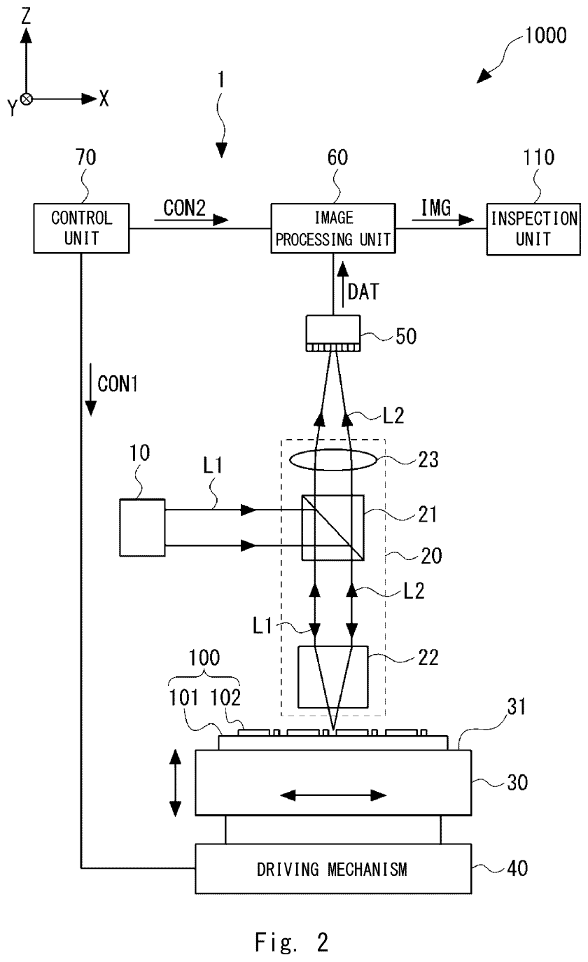

FIG. 1 is a diagram showing an example of a configuration of the optical apparatus according to the first embodiment. FIG. 2 is a diagram showing an example of a configuration of an inspection apparatus according to the first embodiment. As shown in FIG. 2, an inspection unit 110 of an inspection apparatus 1000 inspects a sample 100 for abnormalities, for example, defects, based on an image IMG of the sample 100 captured by an optical apparatus 1.

The optical apparatus 1 will be described below. As shown in FIG. 1, the optical apparatus 1 includes a light source 10, an optical system 20, a stage 30, a driving mechanism 40, a detector 50, an image processing unit 60, and a control unit 70. Note that the optical apparatus 1 may include optical members other than those mentioned above.

Here, for convenience of explanation of the optical apparatus 1, an XYZ-orthogonal coordinate system will be introduced. A stage surface 31, which is a main surface of the stage 30 on which the sample 100 is placed, is defined as an X-Y plane parallel to the X-axis direction and the Y-axis direction. The direction orthogonal to the stage surface 31 is defined as the Z-axis direction. For example, the +Z-axis direction is referred to as upward, and the −Z-axis direction is referred to as downward. Note that the terms upward and downward are used merely for convenience of explanation, and do not indicate the direction in which the optical apparatus 1 is actually disposed.

The light source 10 emits illumination light L1 to the optical system 20. The light source 10 may be a lamp light source, a Light Emitting Diode (LED) light source, a laser light source, or the like. The illumination light L1 may be, for example, visible light, ultraviolet light, or Extreme Ultraviolet (EUV) light.

The optical system 20 is composed of a beam splitter 21, an objective lens 22, and a relay lens 23, and constitutes an image-capturing optical system in which the sample 100 placed on the stage 30 is irradiated with the illumination light L1 emitted from the light source 10, and an image of a reflected light L2 from the sample 100 is formed on the detector 50.

The beam splitter 21 is, for example, a half-silvered mirror, and reflects about ½ of the illumination light L1 toward the objective lens 22. The objective lens 22 illuminates an image-capturing target area of the sample 100 (i.e., an area of the sample 100 whose image is to be captured) placed on the stage surface of the stage 30 with the illumination light L1.

The reflected light L2 generated by illuminating the sample 100 with the illumination light L1 is collected and collimated by the objective lens 22 and is then incident on the beam splitter 21. The beam splitter 21 allows about ½ of the reflected light L2 to be transmitted therethrough. The reflected light L2 transmitted through the beam splitter 21 is converged by the relay lens 23 and is then incident on the detector 50. As a result, an image of the sample 100 is formed on the detector 50.

In the figure, typical optical elements included in the optical system 20 are shown merely for convenience of explanation, and various types of optical elements such as lenses, optical scanners, mirrors, filters, and beam splitters, which are not shown, may be provided in the optical system 20. Further, for example, the optical system 20 may be a confocal optical system. Further, when light having a short wavelength such as EUV light is used as the illumination light L1, the optical system 20 may be a reflective optical system.

Further, in FIG. 1, although the optical apparatus 1 is described as being an optical apparatus of a bright-field illumination system, the illumination system of the optical apparatus 1 is not limited thereto.

In the following description, the reflected light L2 from the sample 100 is also referred to as a secondary ray generated when the sample 100 is illuminated with the illumination light L1. However, the secondary ray is not limited to the reflected light. The secondary ray may be a ray of various kinds such as reflected light, scattered light, fluorescence, and transmitted light generated by illuminating the sample 100 with the illumination light L1.

As described above, the sample 100 is placed on the stage surface 31, which is the upper surface of the stage 30. Therefore, the thickness direction (the height direction) of the sample 100 is the Z-axis direction. The sample 100 may be, for example, a photomask in which a fine pattern 102 is formed in a flat plate member 101 such as mask blanks, or a semi-finished product in a semiconductor process in which a device pattern is formed on a wafer which is a flat plate member. The pattern 102 of the sample 100 may be, for example, formed by a layer of an opaque member laminated on the flat plate member 101 which is transparent to the illumination light L1, or formed by laminating an absorber layer which mainly absorbs the illumination light L1 on a multilayer which mainly reflects the illumination light L1.

The stage 30 is a three-dimensional driven stage provided with the driving mechanism 40. The control unit 70 controls the driving mechanism 40, whereby the stage 30 is driven along each of the X, Y, and Z axes, or driven so as to be further rotatable around the axis. The stage 30 is an example of a holding part (a holding unit) for holding the sample 100. The holding part may be any component other than the stage 30, which component can be driven while holding the sample 100, such as a holder having an electrostatic chuck or a robot arm. A method for driving the stage 30 as an example of a method for driving the holding part will be described in detail later.

The detector 50 detects the reflected light L2 from the sample 100 whose image is formed through the optical system 20, thereby acquiring an image of the sample 100. The detector 50 may be a camera of various image-capturing principles applicable to a Time Delay Integration (TDI) camera such as a Charge Coupled Device (CCD) sensor and a Complementary Metal Oxide Semiconductor (CMOS) sensor.

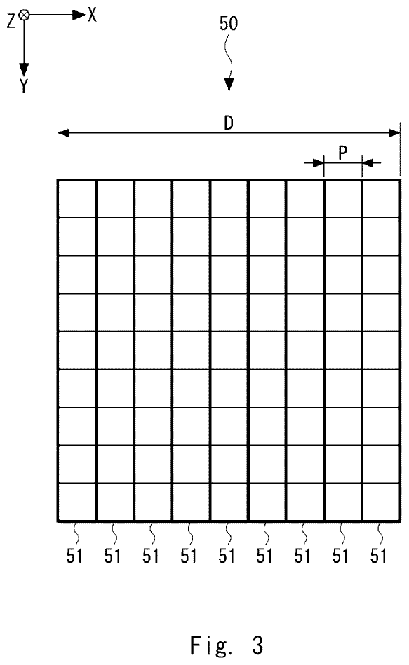

FIG. 3 is a diagram schematically showing a configuration of the detector 50. In the detector 50, N line sensors 51 are arranged at a predetermined pitch P in the X-axis direction on the surface on which light is incident on. Here, N is an integer of two or larger, which is the number of the line sensors 51 arranged in the X-axis direction. In each of the line sensors 51, a plurality of pixels are arranged in the Y-axis direction. FIG. 3 shows an example of a case in which nine of the line sensors 51 are arranged in the X-axis direction and nine pixels are arranged in the Y-axis direction in each of the line sensors 51. Note that the number of line sensors arranged is merely an example, and may be any number of two or larger instead of nine. The number of pixels arranged is merely an example, and may be any number of two or larger instead of nine.

In the inspection apparatus 1000 according to this embodiment, the detector 50 and the image processing unit 60 are configured as a TDI camera that captures an image of the sample 100. The detector 50 outputs a detection signal DAT indicating a result of detection of the reflected light L2 to the image processing unit 60.

The image processing unit 60 processes the detection signal DAT, thereby acquiring a captured image of the sample 100.

The control unit 70 can drive the stage 30 in a desired direction and at a desired speed by providing a control signal CON1 to the driving mechanism 40. Further, the control unit 70 can control image-capturing processing in the image processing unit 60 by providing a control signal CON2 to the image processing unit 60. Thus, the control unit 70 can cause the image processing unit 60 to perform image-capturing when the stage 30 moves to a desired position. As a result, the movement of the stage 30 can be synchronized with an image-capturing timing in the image processing unit 60.

Next, a relationship between the driving of the stage 30 and the image-capturing timing in the optical apparatus 1 will be described. In the optical apparatus 1, the stage 30 can reciprocate in the optical axis direction of the illumination light L1, that is, in the Z-axis direction, which is the thickness direction of the sample 100, in a predetermined cycle and with a predetermined amplitude. Thus, it can be understood that the stage 30 (the holding unit) constitutes optical path length adjustment means mechanism for changing an optical path length between the sample 100 and the detector 50 within a predetermined range.

Further, the stage 30 can move in both or one of the X-axis direction and the Y-axis direction while reciprocating in the Z-axis direction. In this embodiment, in order to make the explanation simple, it is assumed that the stage 30 moves in the X-axis direction while reciprocating in the Z-axis direction. Thus, an image of a specific position of the sample 100 can be sequentially captured by each of the line sensors 51 of the detector 50.

In the inspection apparatus 1000, an image of a specific area of the sample 100 is captured by the left line sensor of two adjacent line sensors, and then an image of the same specific area of the sample 100 is captured by the right line sensor. By sequentially repeating this procedure, images of the same specific area of the sample 100 can be captured by the respective line sensors with a time difference.

In the optical apparatus 1, the control unit 70 controls the stage 30 and the image processing unit 60 in such a manner that the movement of the sample 100 in the X-axis direction and the image-capturing timing are synchronized with each other. By doing so, each time the sample 100 moves by a predetermined pitch ΔX in the X-axis direction and a predetermined pitch ΔZ in the Z-axis direction, the image processing unit 60 acquires an image of the sample 100.

The lateral magnification of an image of the sample 100 projected onto the detector 50 by the optical system 20 is defined as β. By performing image-capturing each time the stage 30 moves the sample 100 by ΔX=P/β in the +X direction under the control of the control unit 70, the respective line sensors 51 can capture images of the same specific area of the sample 100 with a time difference by changing the positions thereof in the Z-axis direction.

Further, the optical apparatus 1 drives the stage 30 in the X-axis direction while reciprocating the stage 30 in the Z-axis direction. That is, an image of the sample 100 is captured a plurality of times while the stage 30 reciprocates in the Z-axis direction once.

Here, the number of times of image-capturing while the stage 30 reciprocates along the Z-axis direction once is defined as q. Note that q is an integer of two or larger. At this time, by reciprocating the stage 30 at least once in the Z-axis direction while an image of a specific position (hereinafter referred to as an image-capturing target area) of the sample 100 crosses the detector 50 in the X-axis direction, an image of the image-capturing target area of the sample 100 can be continuously captured by a plurality of the line sensors 51 a plurality of times in a range between defocused states on the positive and the negative sides with respect to a specific optical path length (may also be referred to as a predetermined optical path length) at which the pattern 102 of the sample 100 is focused and the detector 50 is focused. Note that the specific optical path length may be determined in accordance with the application of the optical apparatus 1, and may be, for example, an optical path length when the illumination light L1 is focused in an area of the sample 100 whose image is to be captured and a secondary ray L2 is focused on the detector 50. Further, the area of the sample 100 on which the illumination light L1 is focused (i.e., the area of the sample 100 whose image is to be captured) may be determined in accordance with the application of the optical apparatus 1, and may be, for example, a transparent substrate layer (or a multilayer) of the sample 100, the pattern 102 (an opaque layer or an absorber layer) of the sample 100, a position of the sample 100 in the thickness direction between the pattern 102 (an opaque layer or an absorber layer) of the sample 100 and a transparent substrate layer (or a multilayer) of the sample 100 a position slightly above the pattern 102 (in the direction away from the substrate), or a position slightly below the transparent substrate layer (or multilayer) of the sample 100.

As described above, since the detector 50 and the image processing unit 60 constitute a TDI camera, a plurality of results of image-capturing in different focused states obtained by capturing an image of the image-capturing target area of the sample 100 a plurality of times are integrated.

Thus, even when there are minute irregularities in the sample 100, the influence of noise when the irregularities are defocused on the negative side and the influence of noise when the irregularities are defocused on the positive side can be canceled. As a result, an image of the sample 100 can be acquired while reducing the influence of noise.

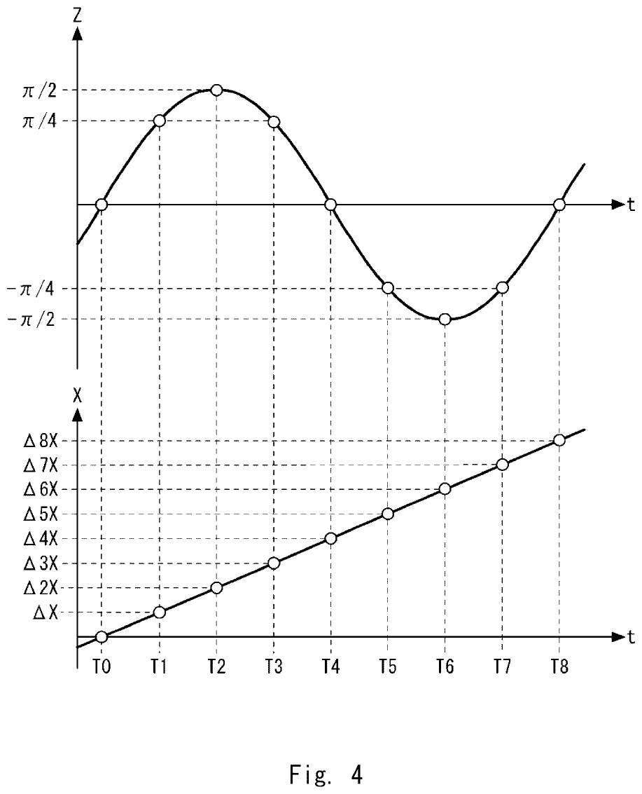

A relationship between the reciprocation of the sample 100 in the Z-axis direction and the image-capturing timing will be described with reference to a specific example. FIG. 4 is a diagram showing an example of movement of the stage. In this example, a description will be given of a case in which the stage 30 reciprocates once while the image of an image-capturing target area OBJ of the sample 100 crosses the nine line sensors 51 of the detector 50 shown in FIG. 3. In this case, the number of times q of the image-capturing performed while the stage 30 reciprocates in the Z-axis direction once is 9.

Further, it is assumed that the initial position of the stage 30 is (X, Z)=(0, 0) and the initial time is TO. Further, it is assumed that the stage 30 is driven so that the positions in the Z-axis direction at the time of the first and the last image-capturing when the stage 30 reciprocates once are the same as each other. Further, in order to facilitate understanding of reciprocating movement of the stage 30, the initial position of the stage is expressed as 0 and the movement pitch ΔZ is expressed as a phase in units of π/4. That is, when k is an integer of 0 or larger but q−1 or smaller, a coordinate Zk of the stage 30 in the Z-axis direction at a timing Tk is expressed by the following equation.

$${Z}_{k} = k \cdot ΔZ = k \cdot 2 π / ( q - 1 ) = k \cdot π / 4 \qquad [ 1 ]$$

Further, a coordinate Xₖ in the X-axis direction is expressed by the following equation.

$${X}_{k} = k \cdot Δ X \qquad [ 2 ]$$

That is, the coordinates of the stage 30 at the image-capturing timings T₀ to T₈ when image-capturing is performed nine times while the stage 30 reciprocates in the Z-axis direction once are as shown below. Note that the coordinates (X₈, Z₈) of the stage 30 at the image-capturing timing T₈ may be the coordinates of the initial position (0, 0) thereof with respect to another different image-capturing target area OBJ of the sample 100. That is, the movement of the following coordinates of the stage 30 may be repeated in accordance with the assumption that the image-capturing timing T₈ is the first image-capturing timing T₀ with respect to another different image-capturing target area OBJ of the sample 100.

$$( {X}_{0} , {Z}_{0} ) = ( 0 , 0 )$$

$$( {X}_{1} , {Z}_{1} ) = ( Δ X , π / 4 )$$

$$( {X}_{2} , {Z}_{2} ) = ( 2 Δ X , π / 2 )$$

$$( {X}_{3} , {Z}_{3} ) = ( 3 Δ X , 3 π / 4 )$$

$$( {X}_{4} , {Z}_{4} ) = ( 4 Δ X , π )$$

$$( {X}_{5} , {Z}_{5} ) = ( 5 Δ X , 5 π / 4 )$$

$$( {X}_{6} , {Z}_{6} ) = ( 6 Δ X , 3 π / 2 )$$

$$( {X}_{7} , {Z}_{7} ) = ( 7 Δ X , 7 π / 4 )$$

$$( {X}_{8} , {Z}_{8} ) = ( 8 Δ X , 2 π )$$

Further, for example, if the initial position of the stage 30 is (X₀, Z₀)=(0, 0) and the stage 30 moves along a sine wave in which an amplitude thereof is set to A for the coordinates in the Z-axis direction, the coordinates of the stage 30 are as follows.

$$( {X}_{0} , {Z}_{0} ) = ( 0 , 0 )$$

$$( {X}_{1} , {Z}_{1} ) = ( Δ X , A \cdot sin ( π / 4 ) ) = ( Δ X , A / √ 2 )$$

$$( {X}_{2} , {Z}_{2} ) = ( 2 Δ X , A \cdot sin ( π / 2 ) ) = ( 2 Δ X , A )$$

$$( {X}_{3} , {Z}_{3} ) = ( 3 Δ X , A \cdot sin ( 3 π / 4 ) ) = ( 3 Δ X , A / √ 2 )$$

$$( {X}_{4} , {Z}_{4} ) = ( 4 Δ X , A \cdot sin ( π ) ) = ( 4 Δ X , 0 )$$

$$( {X}_{5} , {Z}_{5} ) = ( 5 Δ X , A \cdot sin ( 5 π / 4 ) ) = ( 5 Δ X , - A / √ 2 )$$

$$( {X}_{6} , {Z}_{6} ) = ( 6 Δ X , A \cdot sin ( 3 π / 2 ) ) = ( 6 Δ X , - A )$$

$$( {X}_{7} , {Z}_{7} ) = ( 7 Δ X , A \cdot sin ( 7 π / 4 ) ) = ( 7 Δ X , - A / √ 2 )$$

$$( {X}_{8} , {Z}_{8} ) = ( 8 Δ X , A \cdot sin ( 2 π ) ) = ( 8 Δ X , 0 )$$

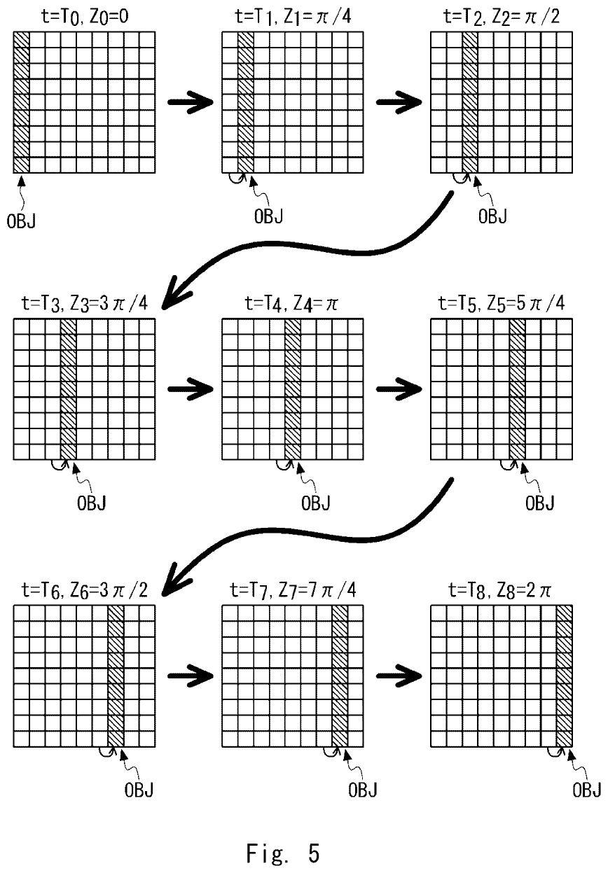

FIG. 5 is a diagram schematically showing a progress when an image of the image-capturing target area OBJ of the sample 100 is captured. In FIG. 5, as an example, the line sensors 51 are arranged in nine rows in the X direction. Since the stage 30 is driven so that the image of the image-capturing target area OBJ is moved by one line sensor in the +X direction at each image-capturing timing, the image-capturing target area OBJ is sequentially shifted by one line in the +X direction. The detector 50 is configured as a sensor of a TDI camera, and therefore the charge of the line sensor that has captured an image of the image-capturing target area OBJ at the immediately preceding image-capturing timing is transferred to the adjacent line sensor 51 in the +X direction. Then an image of the image-capturing target area OBJ is further captured by the line sensor 51 to which the charge has been transferred, so that the charge is further accumulated.

Further, as described above, the stage 30 moves by π/4 along the Z-axis direction at each image-capturing timing, and thus results of the image-capturing in different focused states are integrated in the images of the image-capturing target area OBJ sequentially captured by nine of the line sensors 51. Note that the image captured by the ninth line sensor 51 may not be integrated, because the phase of Z is the same as that of the initial position. In this case, the images of the image-capturing target area OBJ sequentially captured by eight of the line sensors 51 are integrated.

Therefore, in this configuration, the cycle in which the stage 30 reciprocates in the Z-axis direction once is synchronized with the cycle in which results of the image-capturing by a plurality of line sensors are integrated, that is, the cycle in which a plurality of images integrated as images of the same image-capturing target area OBJ of the sample 100 are acquired. For example, the cycle in which results of the image-capturing of the same image-capturing target area OBJ of the sample 100 by a plurality of line sensors are integrated and then images of the above image-capturing target area OBJ are acquired (i.e., the cycle in which a plurality of images integrated as images of the same image-capturing target area OBJ of the sample 100 are acquired) is an integer multiple of one or larger of the cycle in which the stage 30 reciprocates in the Z-axis direction once. That is, during one cycle in which a plurality of images integrated as images of the same image-capturing target area OBJ of the sample 100 are acquired, the stage 30 may be reciprocated in the Z-axis direction at least one or more integer times. Further, as images of the same image-capturing target area OBJ of the sample 100, at least (1) an image when the optical path length between the sample 100 and the detector 50 is a specific optical path length, (2) an image when the optical path length between the sample 100 and the detector 50 is longer than a specific optical path length by at least one amount of change, and (3) an image when the optical path length between the sample 100 and the detector 50 is shorter than a specific optical path length by at least one amount of change equal to the amount of change in (2) may be integrated.

However, the above descriptions are merely examples, and images when the reciprocation of the stage 30 in a predetermined range is performed “less than once” may be integrated. That is, images to be integrated as images of the same image-capturing target area OBJ of the sample 100 may be images acquired when the stage 30 has “reciprocated less than once”. For example, images in a specific phase (an optical path length in a desired range) may be integrated to acquire an image. For example, an image obtained by integrating a plurality of images when corresponding to a specific phase (an optical path length in a desired range) specified by a user, such as when being defocused on the plus side, may be acquired.

As described above, according to the optical apparatus 1, a sample is scanned to capture an image thereof by a TDI camera while the sample is reciprocated in a direction perpendicular to the scanning direction, whereby it is possible to acquire an integrated image of the results of the image-capturing of the same image-capturing target area OBJ in different focused states.

Therefore, even when there are irregularities as a noise source on the sample 100, an image of the bright irregularities and an image of the dark irregularities are integrated, so that the influence of the irregularities on the image IMG can be cancelled. As a result, the noise caused by the irregularities of the sample 100 in the image IMG can be reduced or eliminated.

Therefore, the inspection apparatus 1000 can inspect defects of the sample 100 by using the image IMG in which the noise has been reduced or eliminated. As a result, according to the inspection apparatus 1000, it is possible to improve the accuracy of the inspection by reducing the influence of the noise.

### Second Embodiment

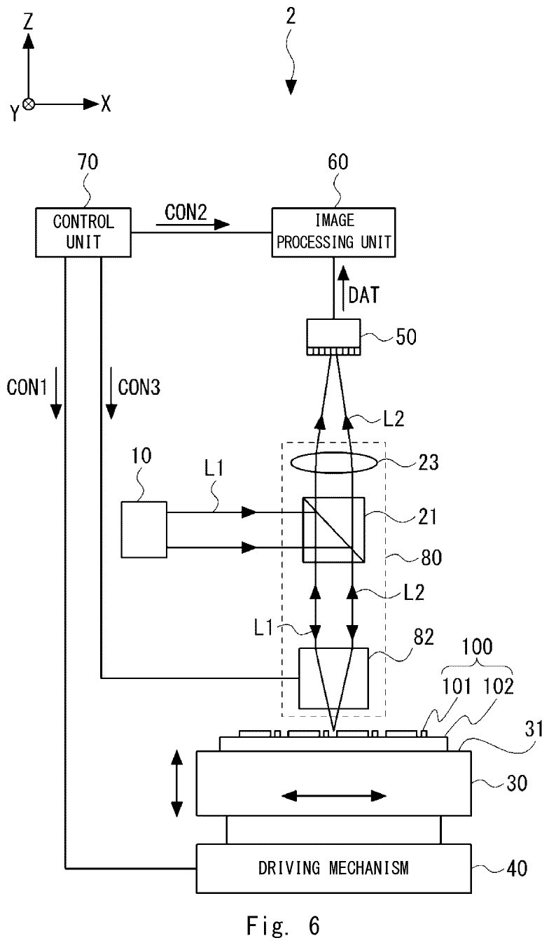

An optical apparatus according to a second embodiment will be described below. FIG. 6 is a diagram schematically showing a configuration of the optical apparatus according to the second embodiment. An optical apparatus 2 has a configuration in which the optical system 20 according to the first embodiment is replaced by an optical system 80. The optical system 80 has a configuration in which the objective lens 22 of the optical system 20 is replaced by an objective lens 82.

The objective lens 82 is configured as a lens capable of adjusting the focal position on the objective side, that is, on the side of the sample 100. For example, the objective lens 82 is configured as a zoom lens capable of changing the focal length of the illumination light L1 that illuminates the sample 100. In this configuration, the control unit 70 can control the focal length of the objective lens 82 by providing a control signal CON3 to the optical system 80.

Note that the objective lens 82 may have any other configuration in which the focal position on the side of the sample 100 can be changed. For example, when the objective lens 82 is a unifocal lens, the focal position of the objective lens 82 can be changed in the Z-axis direction with respect to the sample 100 by changing the position of the objective lens 82 in the Z-axis direction.

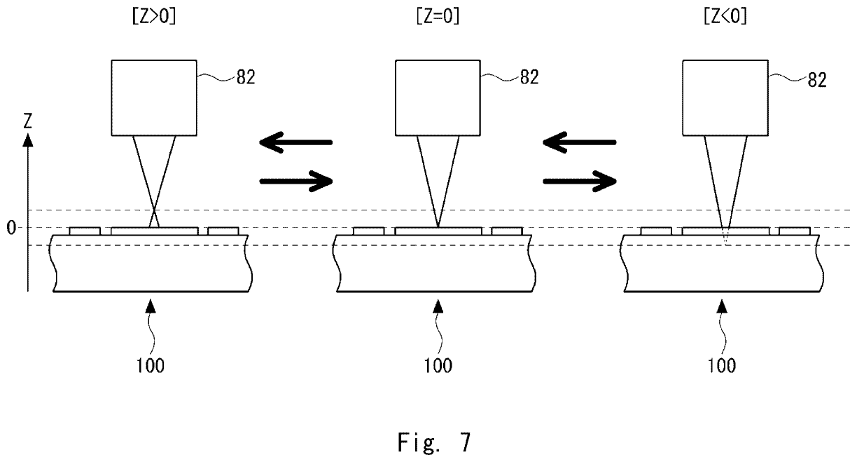

FIG. 7 schematically shows a change in the focal length when the objective lens 82 is configured as a zoom lens. As shown in FIG. 7, the focal length of the illumination light L1 can be appropriately changed by controlling the objective lens 82.

Therefore, in the optical apparatus 2, by moving the focal position of the optical system 80 on the side of the sample 100 along the Z-axis direction using the objective lens 82 instead of reciprocating the stage 30 along the Z-axis direction, the optical path length between the sample 100 and the detector 50 can be changed so as to reciprocate within a predetermined range, like in the first embodiment. Thus, it can be understood that the objective lens 82 constitutes optical path length adjustment means mechanism for changing the optical path length between the sample 100 and the detector 50 within a predetermined range.

In the above description, the focal position of the optical system on the side of the sample 100 is changed. However, a similar effect can be obtained by changing the focal position on the side of the detector 50. That is, the optical system 80 may be configured so as to be able to change the focal position of the reflected light L2 toward the detector 50 from the optical system 80 in the Z-axis direction. In this case, by moving the focal position of the optical system 80 on the side of the detector 50 along the Z-axis direction, the optical path length between the sample 100 and the detector 50 can be changed so as to reciprocate within a predetermined range, like in the first embodiment. Further, in the above description, the focal length of the optical system is changed. However, a similar effect can also be obtained by driving the optical system to change a physical position of the optical system relative to the sample 100. Further, a similar effect can also be obtained by driving the optical system to change a physical position of the optical system relative to the detector 50. Note that the direction along which the focal position is changed may correspond to the direction of the optical axis, and may not necessarily be the Z-axis, depending on the configuration of the optical system.

Further, when the optical path length between the sample 100 and the detector 50 is changed, one of the focal position of the optical system on the side of the sample 100 and the focal position of the optical system on the side of the detector may be moved, or both of them may be moved. Further, if the optical path length between the sample 100 and the detector 50 can be changed, another optical element such as a mirror may be driven in place of or in conjunction with the lens.

Therefore, according to this configuration, by causing the optical system to change the optical path length between the sample 100 and the detector 50, an image of the sample can be captured like in the first embodiment even without moving the stage in the Z-axis direction.

### Third Embodiment

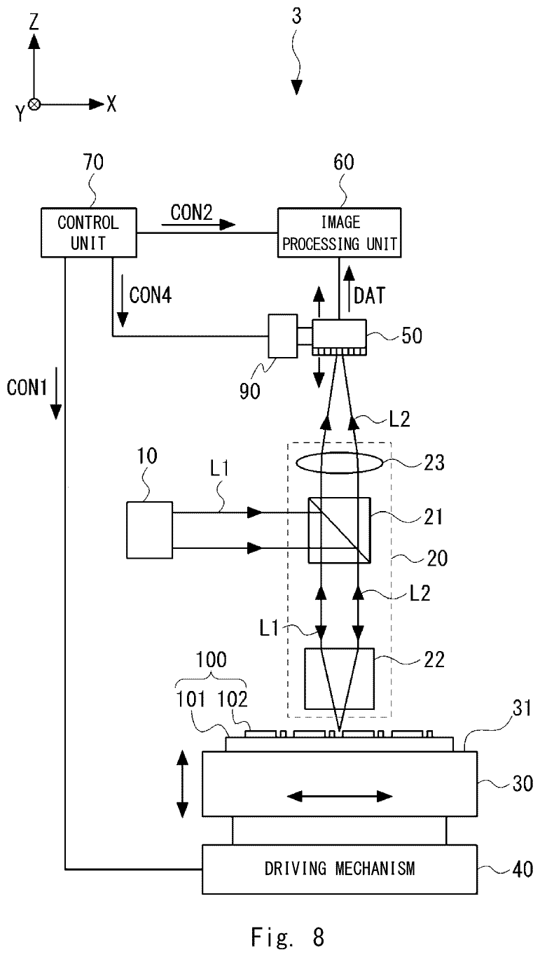

An optical apparatus according to a third embodiment will be described. FIG. 8 is a diagram schematically showing a configuration of the optical apparatus according to the third embodiment. An optical apparatus 3 has a configuration in which a detector driving unit 90 is added to the optical apparatus 1 according to the first embodiment.

The detector driving unit 90 can drive the detector 50 in the Z-axis direction. The control unit 70 controls the driving of the detector 50 by the detector driving unit 90 using a control signal CON4. Therefore, like in the first embodiment, the optical path length between the sample 100 and the detector 50 can be changed within a predetermined range by reciprocating the detector 50 in the Z-axis direction so that a detection surface of the detector 50 is moved within a predetermined range including the focal position of the optical system 20 on the side of the detector 50. Thus, it can be understood that the detector driving unit 90 constitutes optical path length adjustment mechanism for changing the optical path length between the sample 100 and the detector 50 within a predetermined range. The detector driving unit 90 may reciprocate the detector 50 along a direction corresponding to the optical axis, which may be the Z-axis or another axis depending on the configuration of the optical system.

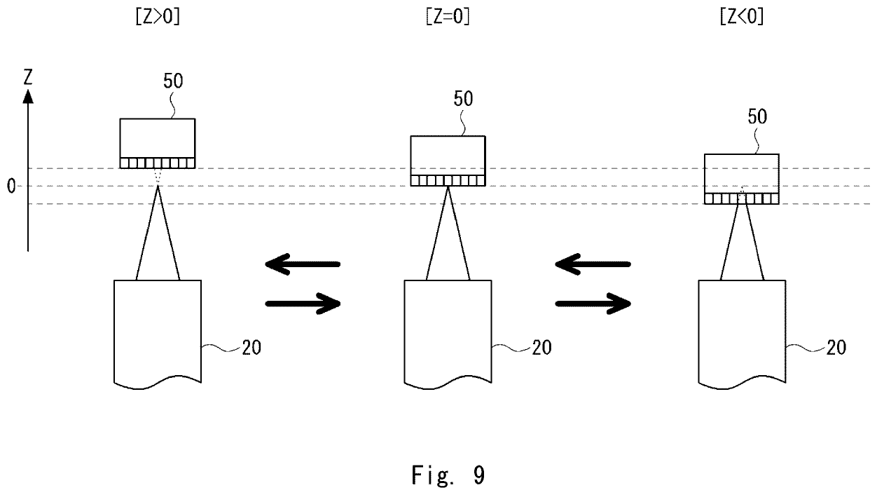

FIG. 9 is a diagram schematically showing a relationship between the detector 50 and the focus of the optical system on the side of the detector 50 when the detector 50 is moved in the Z-axis direction. As shown in FIG. 9, the optical path length between the sample 100 and the detector 50 can be changed as appropriate by moving the detector 50 in the Z-axis direction.

Thus, like in the optical apparatuses 1 and 2, an image of the sample 100 obtained by integrating a result of the image-capturing in a focused state and a result of the image-capturing in a defocused state on each of the positive and negative sides can be captured.

Therefore, according to this configuration, by driving the detector using the detector driving unit, an image of the sample can be captured like in the first and the second embodiments even without moving the stage in the Z-axis direction.

### OTHER EMBODIMENTS

Although the present disclosure has been described with reference to embodiments, the present disclosure is not limited to the above-described embodiments. Various changes that may be understood by those skilled in the art may be made to the configurations and details of the present disclosure within the scope of the present disclosure. Further, each of the embodiments may be combined with at least one of the other embodiments as appropriate.

Needless to say, the inspection apparatus which inspects defects of the sample 100 can be configured by providing the inspection unit 110 in the optical apparatus according to the second and the third embodiments like in the first embodiment.

The optical apparatus according to the above-described embodiments may be incorporated not only into the inspection apparatus, but also into various types of apparatuses using the image IMG of the sample 100, such as a review apparatus which displays the image IMG of the sample 100.

In the review apparatus which displays the image IMG of the sample 100, images when the stage 30 has “reciprocated less than once” may be integrated, for example, images are acquired by integrating images in a specific phase (an optical path length in a desired range). For example, the review apparatus which displays the image IMG of the sample 100 may acquire an image obtained by integrating a plurality of images when corresponding to a specific phase (an optical path length in a desired range), such as when being defocused on the positive side, which is specified based on results by specification acquisition means for receiving specification from a user, and display the acquired image.

Further, the control unit 70 may be capable of switching between a first mode and a second mode. In the first mode, the control unit 70 controls the optical path length adjustment mechanism so that the optical path length between the detector 50 and the imaging target area OBJ is changed, and causes the image processing unit 60 to acquire multiple images at different optical path lengths. In the second mode, the control unit 70 maintains the optical path length constant and causes the image processing unit 60 to acquire multiple images of the imaging target area OBJ under the same optical path length.

The control unit 70 may switch between the first and second modes based on a recipe for inspection or review of the sample 100, or based on characteristics of the sample 100 or a pattern formed thereon. Alternatively, the mode may be switched based on the result of a mode selection operation received from a user. For example, when the recipe is intended to visualize noise due to fine surface irregularities, the second mode may be selected. This allows identification of whether the sample 100 or its patterns are sensitive to such noise. Conversely, when the sample or pattern is expected to be insensitive to the noise, the second mode may also be used. On the other hand, if the sample or pattern is sensitive to such noise and the recipe is intended to reduce or eliminate the noise, the first mode may be selected. The mode selection operation may be performed through a graphical user interface (GUI) or through an automated system based on measurement history or identification of sample or pattern characteristics.

The above-described optical system 20 is merely an example, and it may instead have any other configuration in which the sample 100 held by the stage 30 or other holding means can be irradiated with the illumination light L1 emitted from the light source 10 and an image of the secondary ray from the sample 100 can be formed on the detector 50. For example, when the illumination light L1 is EUV light, the optical system 20 may be configured as a reflective optical system, to thereby guide the illumination light L1 to the sample 100. Further, the secondary ray from the sample 100 may be guided to the detector 50 by the reflective optical system.

As used herein, the term “optical path length adjustment mechanism” is not limited to any specific configuration and may include any mechanical, optical, or electromechanical structure that can adjust the optical path length between the object (e.g., a sample) and the detector. For example, the optical path length adjustment mechanism may include: a driving mechanism for moving the stage (a holding unit) or sample; a driving mechanism for moving the detector; a zoom lens or other lens structure whose focal position or focal length can be varied; an optical system that changes a relative physical position between optical components (e.g., lenses, mirrors) and the object or detector; a mechanism for changing the optical path using reflective components such as movable mirrors or prisms. In other words, any mechanism that effectively causes a variation in the optical path length, including software-controlled elements or programmable optical components, may serve as an optical path length adjustment mechanism as long as it achieves the desired functional effect of varying the optical path length between the object and the detector. Therefore, the optical path length adjustment mechanism is to be interpreted broadly to include all such functionally equivalent arrangements.

In another embodiment, the stage (the holding unit) and/or the detector may be positioned such that a main surface of the object is tilted at a predetermined angle with respect to a plane conjugate with the detection surface of the detector. In such a configuration, the optical path length between the object and the detector varies across the object due to the tilt. Furthermore, the control unit may cause the image processing unit to acquire images of the imaging target area at different optical path lengths by changing the relative position of the imaging target area with respect to the conjugate plane. This change may include a component in a direction orthogonal to the axis of the tilt on the main surface of the object. As a result, it becomes possible to obtain images at multiple optical path lengths without necessarily requiring reciprocating movement of the object or the detector in the direction of the optical axis or thickness direction of the object. Such a configuration, in which the relative position between the conjugate plane and the imaging target area OBJ is varied due to the tilt of the object surface, may also be considered an example of the optical path length adjustment mechanism as used herein.

In the above-described embodiments, the movement pitch ΔZ of the stage 30 is expressed by a phase. However, ΔZ may be any fixed distance in the Z-axis direction. Further, the movement pitch during which the stage 30 reciprocates in the Z-axis direction once may be a constant value or a variable value. The movement in the Z-axis direction may be performed along any waveform, such as a sinusoidal wave, a triangular wave, or a waveform obtained by combining these waves.

In the above-described embodiments, the optical apparatus according to the present disclosure has been described mainly as a hardware configuration. However, the present disclosure is not limited thereto. It is also possible to implement the optical apparatus according to the present disclosure by causing a computer to execute a computer program for performing any processing. The above processing may be implemented by causing a computer including at least one processor (e.g., a microprocessor, a CPU, a GPU, an MPU, a Digital Signal Processor (DSP)) to execute a program. Specifically, one or a plurality of programs including instructions for causing a computer to perform an algorithm related to the above transmission signal processing or reception signal processing may be created, and the created program(s) may be supplied to the computer.

The computer program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

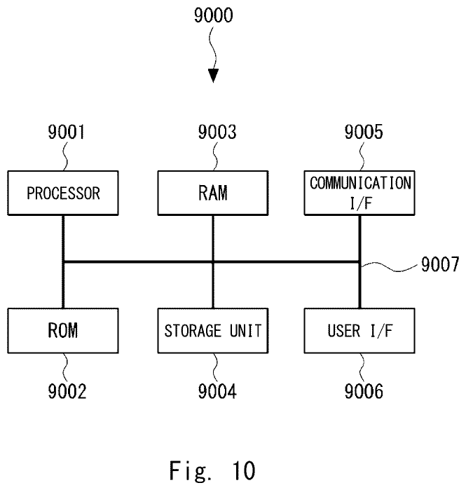

In the following description, an example of a configuration of a computer for implementing the optical apparatus will be given. FIG. 10 is a diagram showing an example of a configuration of the computer for implementing an image processing unit and a control unit of the optical apparatus. The image processing unit and the control unit of the optical apparatus can be implemented by a computer 9000 such as a dedicated computer or a personal computer (PC). However, the computer does not need to be physically a single computer, and may be composed of a plurality of computers when processes are executed in a distributed manner. As shown in FIG. 10, the computer 9000 includes, for example, a processor 9001, a Read Only Memory (ROM) 9002, a Random Access Memory (RAM) 9003, a storage unit 9004, a communication interface 9005, and a user interface 9006.

The processor 9001, the ROM 9002, the RAM 9003, the storage unit 9004, the communication interface 9005, and the user interface 9006 are connected to one another through a bus 9007 so that they can communicate with one another. Note that, although the description of OS software or the like for causing the computer to operate will be omitted, it is installed on the computer 9000 as appropriate.

The ROM 9002 is composed of, for example, a non-volatile semiconductor storage device. The ROM 9002 stores information such as various types of programs used by the computer 9000.

The storage unit 9004 is composed of, for example, various types of storage devices such as a hard disk or a solid state disk. Further, the storage unit 9004 is not limited to being a storage device mounted on the computer 9000, and may instead be a storage device located outside the computer 9000. The storage device located outside the computer 9000 may be a cloud storage connected to the computer 9000 through various types of network communication means, for example, a network. The storage unit 9004 stores information such as various types of programs and data used by the computer 9000.

The RAM 9003 is composed of a volatile semiconductor storage device or the like. Information such as programs and data used by the processor 9001 is loaded into the RAM 9003 as appropriate from one or both of the ROM 9002 and the storage unit 9004.

The processor 9001 may be composed of, for example, a Central Processing Unit (CPU). Further, the processor 9001 may include not only a CPU but also a Graphics Processing Unit (GPU). The GPU is suitably used to perform routine processes in parallel, and by applying the GPU to, for example, processes in a neural network, it is possible to improve the processing speed compared to the CPU. The processor 9001 executes various processes based on various types of programs stored in the ROM 9002 or various types of programs and data stored in the RAM 9003 as appropriate. Further, the processor 9001 may store data generated by the processing in the RAM 9003 or the storage unit 9004 as appropriate.

The communication interface 9005 is an interface for connecting the computer 9000 to a communication network such as the Internet or an intranet through various types of wired or wireless communication means, etc. Thus, the computer 9000 can communicate with other apparatuses, systems, sensors, and the like connected to the communication network.

The user interface 9006 includes, for example, a display unit that provides information in such a manner that a user can recognize it by means of a display apparatus or the like, and a voice output unit that outputs information by voice. Further, the user interface 9006 includes input units such as a keyboard, a mouse, and a touch panel with which it is possible to input information to the computer 9000 through an operation performed by a user. Further, the user interface 9006 may include devices such as sensors that acquire information useful to a user.

Although the computer 9000 has been described here as being one apparatus, this is merely an example. The computer 9000 may be composed of a plurality of apparatuses physically separated from each other. Some of the plurality of apparatuses may be portable apparatuses, and some other of the plurality of apparatuses may be stationary apparatuses.

Although the present disclosure has been described with reference to embodiments, the present disclosure is not limited to the above-described embodiments. Various changes that may be understood by those skilled in the art may be made to the configurations and details of the present disclosure within the scope of the present disclosure. Further, each of the embodiments may be combined with at least one of the other embodiments as appropriate.

Each of the drawings or figures is merely an example to illustrate one or more embodiments. Each figure may not be associated with only one particular embodiment, but may be associated with one or more other embodiments. As those of ordinary skill in the art will understand, various features or steps described with reference to any one of the figures can be combined with features or steps illustrated in one or more other figures, for example, to produce embodiments that are not explicitly illustrated or described. Not all of the features or steps illustrated in any one of the figures to describe an embodiment are necessarily essential, and some features or steps may be omitted. The order of the steps described in any of the figures may be changed as appropriate.

The first to third embodiments can be combined as desirable by one of ordinary skill in the art. From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

The following configuration is also encompassed by the technical though of the embodiments.

### (Supplementary Note 1)

An optical apparatus comprising:
a detector configured to detect light;
an optical system configured to irradiate an object with illumination light and guide a secondary ray generated when the object is irradiated with the illumination light to the detector;
a holding unit configured to hold the object;
a driving unit configured to drive the holding unit;
a memory storing a program; and
one or more processors configured to execute the program stored in the memory to:
generate an image of the object based on detection results of the secondary ray by the detector;
control the driving unit so as to move the holding unit in a state where a component in a thickness direction of the object is included so that an optical path length between the object and the detector is changed;
acquire multiple images of the object while changing the optical path length between the object and the detector; and
generate the image of the object based on a cumulative result of the acquired multiple images.

### (Supplementary Note 2)

An optical apparatus comprising:
a detector configured to detect light;
an optical system configured to irradiate an object with illumination light and guide a secondary ray generated when the object is irradiated with the illumination light to the detector;
a memory storing a program; and
one or more processors configured to execute the program stored in the memory to:
generate an image of the object based on detection results of the secondary ray by the detector;
control the optical system to change at least one of a focal length of the optical system on a side of the object and a focal length of the optical system on a side of the detector so that an optical path length between the object and the detector is changed;
acquire multiple images of the object while changing the optical path length between the object and the detector; and
generate the image of the object based on a cumulative result of the acquired multiple images.

### (Supplementary Note 3)

An optical apparatus comprising:
a detector configured to detect light;
an optical system configured to irradiate an object with illumination light and guide a secondary ray generated when the object is irradiated with the illumination light to the detector;
a memory storing a program; and
one or more processors configured to execute the program stored in the memory to:
generate an image of the object based on detection results of the secondary ray by the detector;
control the optical system to change at least one of a position of the optical system relative to the object and a position of the optical system relative to the detector so that an optical path length between the object and the detector is changed,
acquire multiple images of the object while changing the optical path length between the object and the detector; and
generate the image of the object based on a cumulative result of the acquired multiple images.

### (Supplementary Note 4)

An optical apparatus comprising:
a detector configured to detect light;
an optical system configured to irradiate an object with illumination light and guide a secondary ray generated when the object is irradiated with the illumination light to the detector;
a detector driving unit configured to drive the detector; and
a memory storing a program; and
one or more processors configured to execute the program stored in the memory to:
generate an image of the object based on detection results of the secondary ray by the detector;
control the detector driving unit so as to move the detector in a state where a component in a thickness direction of the detector is included so that the optical path length between the object and the detector is changed,
acquire multiple images of the object while changing the optical path length between the object and the detector; and
generate the image of the object based on a cumulative result of the acquired multiple images.

What is claimed is:

1. An optical apparatus comprising:
a detector configured to detect light;
an optical system configured to irradiate an object with illumination light and guide a secondary ray generated when the object is irradiated with the illumination light to the detector;
an optical path length adjustment mechanism configured to adjust an optical path length between the object and the detector; and
a memory storing a program; and
one or more processors configured to execute the program stored in the memory to:
generate an image of the object based on detection results of the secondary ray by the detector;
control the optical path length adjustment mechanism to change the optical path length between the object and the detector;
acquire multiple images of the object while changing the optical path length between the object and the detector; and
generate the image of the object based on a cumulative result of the acquired multiple images.

2. The optical apparatus according to claim 1, further comprising: a holding unit configured to hold the object; and a driving unit configured to drive the holding unit, the holding unit and the driving unit constituting the optical path length adjustment mechanism,
wherein the control unit controls the driving unit so as to move the holding unit in a state where a component in a thickness direction of the object is included so that the optical path length between the object and the detector is changed.

3. The optical apparatus according to claim 1, wherein
the optical system is configured as the optical path length adjustment mechanism, and
the control unit changes at least one of a focal length of the optical system on a side of the object and a focal length of the optical system on a side of the detector so that the optical path length between the object and the detector is changed.

4. The optical apparatus according to claim 1, wherein
the optical system is configured as the optical path length adjustment mechanism, and
the control unit changes at least one of a position of the optical system relative to the object and a position of the optical system relative to the detector so that the optical path length between the object and the detector is changed.

5. The optical apparatus according to claim 1, further comprising a detector driving unit configured to drive the detector, the detector driving unit constituting the optical path length adjustment mechanism,
wherein the control unit controls the detector driving unit so as to move the detector in a state where a component in a thickness direction of the detector is included so that the optical path length between the object and the detector is changed.

6. The optical apparatus according to claim 3, further comprising:
a holding unit configured to hold the object; and
a driving unit configured to drive the holding unit,
wherein the control unit controls the driving unit so as to move the holding unit.

7. The optical apparatus according to claim 2, wherein
the detector comprises a plurality of sensors arranged in a predetermined direction orthogonal to the thickness direction of the detector, each of the plurality of sensors being configured to detect the secondary ray,
the control unit controls the driving unit so as to drive the holding unit so that images of the object acquired by the plurality of sensors move along the predetermined direction, and
the control unit controls the image processing unit so as to acquire images of the same area of the object by the plurality of respective sensors as the plurality of images, and to acquire an image of the same area of the object based on a result of integration of the acquired plurality of images.

8. The optical apparatus according to claim 7, wherein the control unit controls the optical path length adjustment mechanism so that an optical path length between one of the two adjacent sensors and the same area of the object differs from an optical path length between the other of the two adjacent sensors and the same area of the object.

9. The optical apparatus according to claim 1, wherein the control unit controls the optical path length adjustment mechanism so that the optical path length between the object and the detector is reciprocated a predetermined number of times within a predetermined range, the predetermined number of times being at least once.

10. The optical apparatus according to claim 9, wherein the predetermined range includes a predetermined optical path length at which the illumination light is focused within an area of the object whose image is to be captured and the secondary ray is focused on the detector.

11. The optical apparatus according to claim 10, wherein the predetermined optical path length is an optical path length serving as a center of the predetermined range.

12. The optical apparatus according to claim 9, wherein the image processing unit integrates the images of the object acquired while the optical path length between the object and the detector is reciprocated the predetermined number of times within the predetermined range.

13. An inspection apparatus comprising:
the optical apparatus according to claim 1; and
an inspection unit configured to inspect the object based on the image of the object acquired by the image processing unit.

14. An image-capturing method performed in an optical apparatus comprising: a detector configured to detect light; an optical system configured to irradiate an object with illumination light and guide a secondary ray generated when the object is irradiated with the illumination light to the detector; and optical path length adjustment mechanism configured to adjust an optical path length between the object and the detector; a memory storing a program; and one or more processors configured to execute the program stored in the memory, the image-capturing method causing the one or more processors to execute the program to:
generate an image of the object based on detection results of the secondary ray by the detector;
control the optical path length adjustment mechanism to change the optical path length between the object and the detector;
acquire multiple images of the object while changing the optical path length between the object and the detector; and
generate the image of the object based on a cumulative result of the acquired multiple images.

15. A non-transitory computer readable medium storing a program for causing a processing apparatus to perform processes, the processing apparatus being configured as a computer that is configured to perform image-capturing processing in an optical apparatus comprising: a detector configured to detect light; an optical system configured to irradiate an object with illumination light and guide a secondary ray generated when the object is irradiated with the illumination light to the detector; and an optical path length adjustment mechanism configured to adjust an optical path length between the object and the detector; a memory storing the program; and one or more processors configured to execute the program stored in the memory, the program causing the one or more processors to:
generate an image of the object based on detection results of the secondary ray by the detector;
control the optical path length adjustment mechanism to change the optical path length between the object and the detector;
acquire multiple images of the object while changing the optical path length between the object and the detector; and
generate the image of the object based on a cumulative result of the acquired multiple images.
